(19) United States
(12) Patent Application Publication
(10) Pub. No.: US 2013/0323661 A1
(43) Pub. Date: Dec. 5, 2013

(54) LONG FLAME PROCESS HEATER

(71) Applicant: ClearSign Combustion Corporation, Seattle, WA (US)

(72) Inventors: DAVID B. GOODSON, Bellevue, WA (US); IGOR A. KRICHTAFOVITCH, KIRKLAND, WA (US); TRACY A. PREVO, SEATTLE, WA (US); CHRISTOPHER A. WIKLOF, EVERETT, WA (US)

(73) Assignee: CLEARSIGN COMBUSTION CORPORATION, SEATTLE, WA (US)

(21) Appl. No.: 13/907,136

(22) Filed: May 31, 2013

Related U.S. Application Data
(60) Provisional application No. 61/654,086, filed on Jun. 1, 2012.

(51) Int. Cl. C04B 2/10; F27B 9/06; F27B 9/00

(52) U.S. Cl. CPC C04B 2/10; F27B 9/00; F27B 9/06
USPC 432/20; 432/140; 432/108

(57) ABSTRACT

A flame used to heat a process material may be extended or otherwise shaped by the application of voltages using electrodes.

### CROSS-REFERENCE TO RELATED APPLICATIONS

The present application claims priority benefit from U.S. Provisional Patent Application No. 61/654,086, entitled “LONG FLAME PROCESS HEATER”, filed Jun. 1, 2012; which, to the extent not inconsistent with the disclosure herein, is incorporated by reference.

### BACKGROUND

Various applications may use flame radiant heating to provide direct heating to a process material. Such applications may range from salamander broilers used in restaurants to heat food, to high temperature calciners, such as may be used to heat limestone to make Portland cement clinkers or gas side-fired kilns used for preparing float-glass by the so-called Pilkington process. Conventional systems are typically characterized by flame lengths that are determined by flame momentum and/or buoyancy. Moreover, conventional flames may exhibit significant flicker, which can introduce unwanted heating variations that can limit product quality and consistency and/or require more complex, multiple burner arrangements.

FIG. 1 is a depiction 101 of a variation in heating modes between radiation and convection that may characterize prior art flame process heating applications. The vertical axis depicts a mode of heat transfer, which in the depiction is simplified to either radiation or convection. In actual implementations, heat transfer may generally be a mixture of radiation, convection, and conduction; however the indicated simplification is useful for understanding a shortcoming of the prior art. The x-axis corresponds to distance x from a burner nozzle, which may be presumed to be coincident with the graph origin. As shown in FIG. 1, a process material disposed or passing parallel to a flame may receive primarily radiation heating in a first region 102. In the first region 102, the flame may be understood to be momentum driven and/or may be steady, such that the process material receives substantially constant radiation from the flame. In a second region 104, the process material may intermittently receive radiation heating and convection heating. Radiation heating and convection heating may be referred to as “H-modes”. For example, the second region 104 may be characterized by flame flicker or vortex shedding where sometimes the flame radiates to the process material and at other times is not present, such that heating is dominated by convection. Finally, at a distal region 106, the flame may be substantially never present and substantially all heating may be via convection heating.

One problem with the prior art situation depicted in FIG. 1 may include uncertainty and relative lack of control in the second region 104. Another problem with the situation depicted in FIG. 1 may include substantially no radiation in the distal region 106. In applications where process material heating is a batch process, the depiction of FIG. 1 may correspond to variable heating across a range of process material locations x. In applications where process material heating is a continuous flow process, the depiction of FIG. 1 may correspond to uncertainty in the amount of heating received by the process material.

What is needed is a technology that can produce a consistent long flame for direct, uniform radiative heating of a process material with minimum variation in flame heating due to processes such as flame flicker.

### SUMMARY

According to an embodiment, a long flame process heater may be configured to reliably provide radiation heating to a process material. Compared to previous systems, the long flame process heater may include a flame extension mechanism configured to stably hold the long flame with reduced flicker and/or under a reduced or substantially absent requirement for imparting momentum onto the flame with high fuel pressure, high air velocity, and/or secondary air manipulation. According to embodiments, the flame may be held responsive to a voltage applied to the flame and charge transfer or capacitive coupling to a field electrode held at one or more distal locations from a burner.

According to an embodiment, a long flame process heater may include a charge electrode configured to impart a voltage or majority charge to a flame, such that the flame carries the voltage or majority charge, a field electrode disposed distal to the charge electrode, and a burner supporting the flame along an axis parallel to a process material. The field electrode may be configured to attract the voltage or majority charge carried by the flame with a second voltage nearer to ground than or opposite in sign to the voltage or majority charge carried by the flame.

According to another embodiment, a method for radiantly heating a process material with a flame may include supporting a flame proximate to a process material, causing the flame to carry a voltage or a majority charge, and attracting the voltage or majority charge and the flame toward a field electrode to extend the flame across the process material.

According to another embodiment, a kiln configured to heat a process material may include an electrode or an electrode array supported relative to the process material and a voltage controller operatively coupled to the electrode or electrode array. The voltage controller may be configured to drive the electrode or electrode array to one or more of a sequence of electric field states to extend a combustion reaction across the process material, the combustion reaction being configured to act as a radiation heat source for the process material.

According to another embodiment, a method for making a product by a process may include heating a process material by radiation from a flame and controlling the flame shape to expose the process material to radiation heating by applying one or more of a sequence of electric fields to the flame.

According to another embodiment, a system for making a high consistency calcined material may include a rotating or stationary process vessel configured to receive a continuous stream of a raw material. A burner or burners may be configured to support a flame or a plurality of flames, the flame or flames being disposed to selectively heat the raw material, an intermediate product reacted from the raw material, and a calcined material made from the intermediate product (collectively, process material) and to provide substantially all the calcining energy received by the process material. An electric field application system may be configured to control a spatial distribution of a radiant energy source formed by the flame by controlling one or more electric fields impressed upon the flame and a region near the flame.

### BRIEF DESCRIPTION OF THE DRAWINGS

FIG. 1 is a depiction of a variation in heating modes between radiation and convection that may characterize flame process heating applications, according to the prior art.

FIG. 2 is a diagram of a long flame process heater, according to an embodiment.

FIG. 3 is a diagram showing heating mode stabilization between radiation and convection that may be produced with the long flame process heater of FIG. 2, according to an embodiment.

FIG. 4 is a diagram of a long flame process heater including a plurality of ladder electrodes for lengthening a flame, according to an embodiment.

FIG. 5 is a diagram of a long flame process heater including a field electrode positioning mechanism for lengthening a flame, according to an embodiment.

FIG. 6 is a diagram of a long flame process heater with a plurality of charge electrodes disposed around one or more centrally located field electrodes, according to an embodiment.

FIG. 7 is a flow chart showing a method for radiantly heating a process material with a flame.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

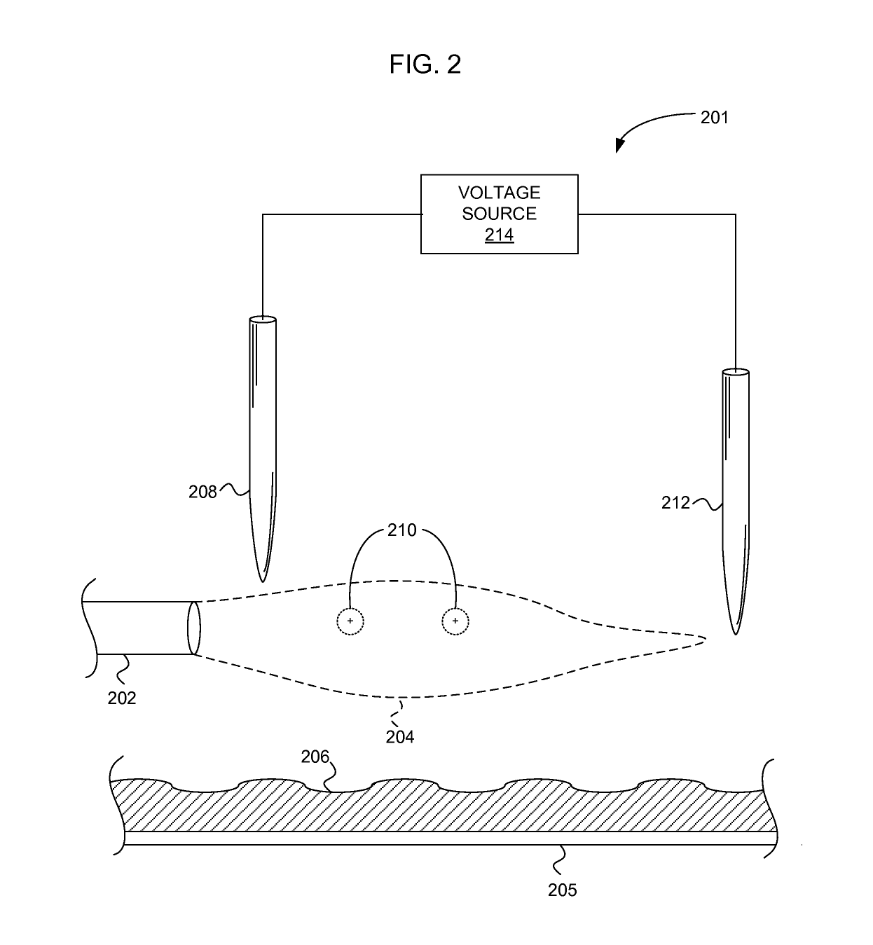

FIG. 2 is a diagram of a long flame process heater 201, according to an embodiment. A long flame process heater 201 may be configured to impart radiant heat to a process material 206. The process material 206 may be visualized as extending through the plane of FIG. 2. The axis of the flame 204 is referred to as parallel to the process material 206 because it extends along a direction that generally lies in a plane parallel to a plane or line defined by the surface of the process material 206. The flame 204 can alternatively or additionally be referred to as parallel to the process material 206 because crosses an imaginary axis defined as generally normal to the surface of the process material 206.

The process material 206 may be supported or conveyed by a mechanism 205. The support mechanism or conveyor 205 may be substantially planar, in which this case the normal axis to the process material 206 may be defined as normal to the support mechanism or conveyor 205. In some applications, the support mechanism or conveyor 205 may include the inside of a rotating cylinder such as a rotary kiln shell. In such cases, the normal axis to the process material 206 may be defined as a radial axis substantially passing through the center axis of the rotating cylinder.

In embodiments in which the support mechanism or conveyor 205 and process material 206 are in motion, the axis of the flame 204 may be transverse and parallel to, or alternatively at least partly across, a direction of movement of a support mechanism or conveyor 205 and process material 206.

In an embodiment, a charge electrode 208 may be configured to impart an electrified state to flame 204 that may include a voltage or majority charge 210. A field electrode 212 may be disposed distal to charge electrode 208 and burner 202, along an axis parallel to a process material 206. The field electrode 212 may be configured to attract the voltage or majority charge 210 carried by flame 204 with a second voltage that is nearer to ground than or opposite in sign (i.e., opposite in polarity) to the voltage or majority charge 210.

A burner 202 may be configured to support the flame 204 for radiation heat transfer to the process material 206. A process material support mechanism or conveyor 205 may be configured to support or convey the process material 206 while it is exposed to radiation heat transfer from the flame 204. The process material support mechanism or conveyor 205 may include a rack configured to support a batch of process material 206, and/or may include a rotating kiln shell, for example.

The charge electrode 208 and the field electrode 212 may be configured to cooperate to draw the flame 204 to a stable length longer than a stable length achievable without the cooperation of the charge electrode 208 and the field electrode 212. Moreover, charge electrode 208 and field electrode 212 may be configured to cooperate to draw the flame 204 to a stable length having less flicker and/or less length variation than a length achievable without the cooperation of the charge electrode and the field electrode 212.

A voltage source 214 may be operatively coupled to the charge electrode 208 and may in addition be operatively coupled to the field electrode 212. The voltage source 214 may be configured to apply a DC voltage to charge electrode 208 and/or voltage or majority charge 210 to the flame 204. Alternatively, the voltage source 214 may be configured to apply a time-varying voltage to the charge electrode 208 and/or the voltage or majority charge 210 to the flame 204. The time-varying voltage may be a periodic voltage waveform having a frequency between 50 and 1500 Hz, for example. In some embodiments, the time-varying voltage may have a frequency between 200 and 800 Hz. A periodic voltage waveform applied to charge electrode 208 may have a voltage between 1 kV and 100 kV, for example. The periodic voltage waveform may have a shape including a sinusoidal wave, a square wave, a sawtooth wave, a triangular wave, a truncated triangular wave, a logarithmic wave, an exponential wave, or an arbitrary wave shape including combinations of the above. In one embodiment, the charge electrode 208 can be in at least intermittent contact with the flame 204, and can be energized to approximately 15 kilovolts.

As indicated above, the system depicted in FIG. 2 can use a substantially constant or DC voltage or charge density applied to the flame. In such a case, the field electrode 212 can be maintained at voltage ground or at a DC voltage opposite in polarity to the voltage applied to the charge electrode 208. In other embodiments, an alternating polarity voltage can be applied to the charge electrode 208. In such other embodiments, the field electrode 212 can be maintained at voltage ground or can have an alternating polarity voltage opposite in sign to and synchronous with the alternating polarity voltage applied to the charge electrode.

The field electrode 212 can operate by maintaining electrical continuity with the charge electrode 208 via current flowing through the flame 204. The flow of current in the flame tends to maintain a long flame shape that stretches between the electrodes 208, 212.

While description herein, for reasons of clarity, refers to the charge electrode 208 as supplying voltage and the field electrode 212 as interacting with the supplied voltage, it will be understood that the voltage relationship between the charge electrode 208 and field electrode 212 can be reversed, with the field electrode 212 supplying charge and the charge electrode 208 acting as a counter electrode. Looked at another way, the charge electrode 208 can be disposed at a distal end of the flame 204 and the field electrode 212 can be disposed near a proximal end of the flame, relative to the burner 202.

A sensing circuit (not shown) may be configured to sense current flow between the charge electrode 208 and the field electrode 212. One or more of voltage control logic, waveform duty cycle logic, waveform shape logic, or waveform frequency logic may be operatively coupled to the sensing circuit and configured to control one or more of voltage, waveform duty cycle, waveform shape, or waveform frequency responsive to the sensed current flow.

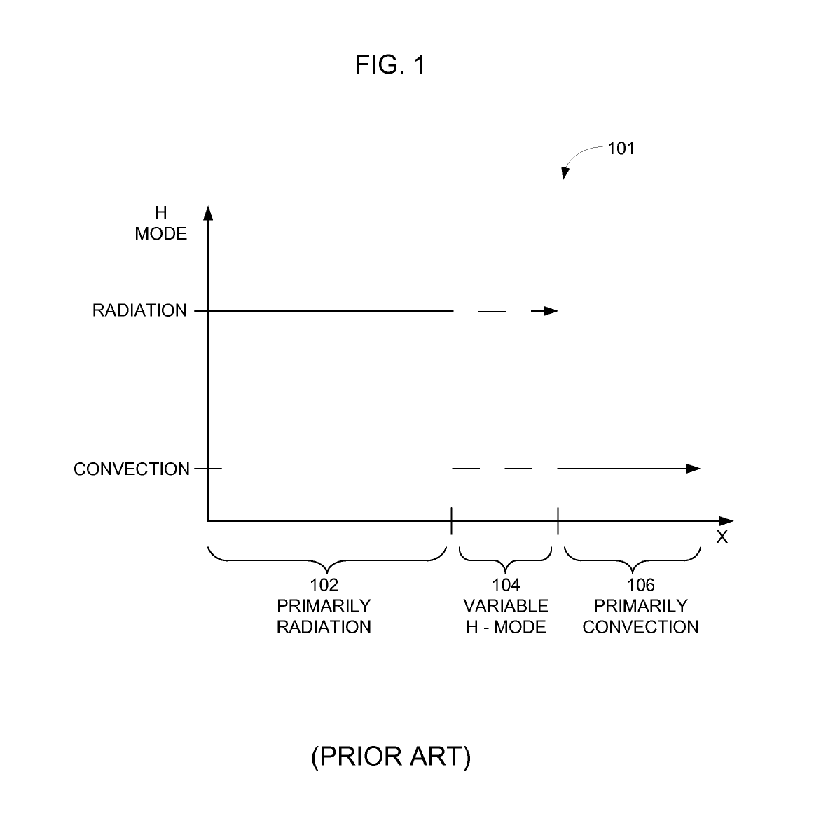

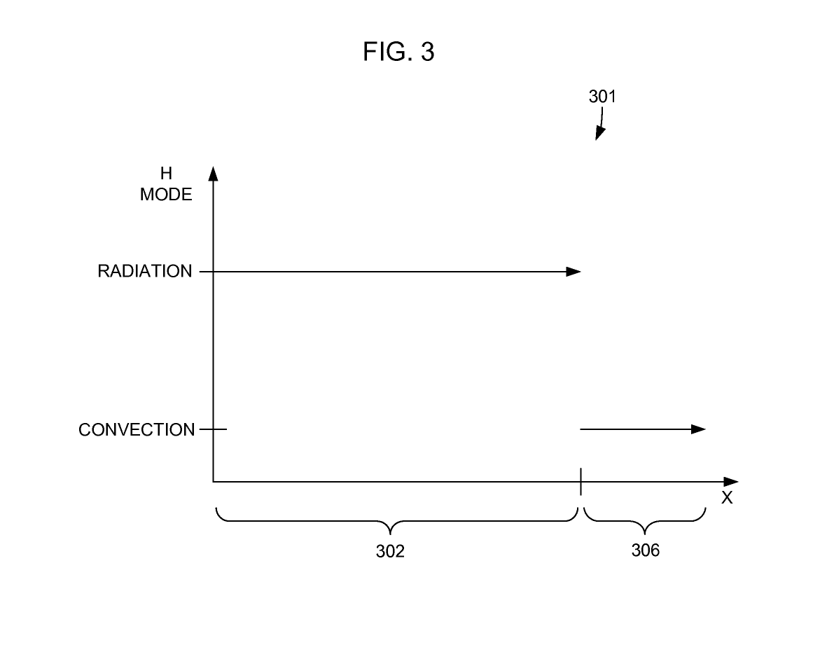

FIG. 3 is a diagram 301 showing stability in heating modes between radiation and convection that may be provided by the long flame process heater 201 of FIG. 2 (and other embodiments shown herein). Contrasting FIG. 3 with FIG. 1 depicting the prior art, it may be seen that in FIG. 3 the region 302 in which the heating mode is primarily radiant may be lengthened compared to the first region 102 in FIG. 1. Moreover, the second region 104 in which the heating mode is variable between radiant and convective may be decreased or substantially eliminated. The region 306 in which the heating mode is primarily convective may be shortened in comparison with the distal region 106 in FIG. 1. It may be noted that the second region 104 of variable heating mode corresponds to the effects of flickering and instability in the flame 204 (shown in FIG. 2). The reduction or elimination of flickering and/or instability in the flame 204 is among the improvements that may be provided by the long flame process heater 201.

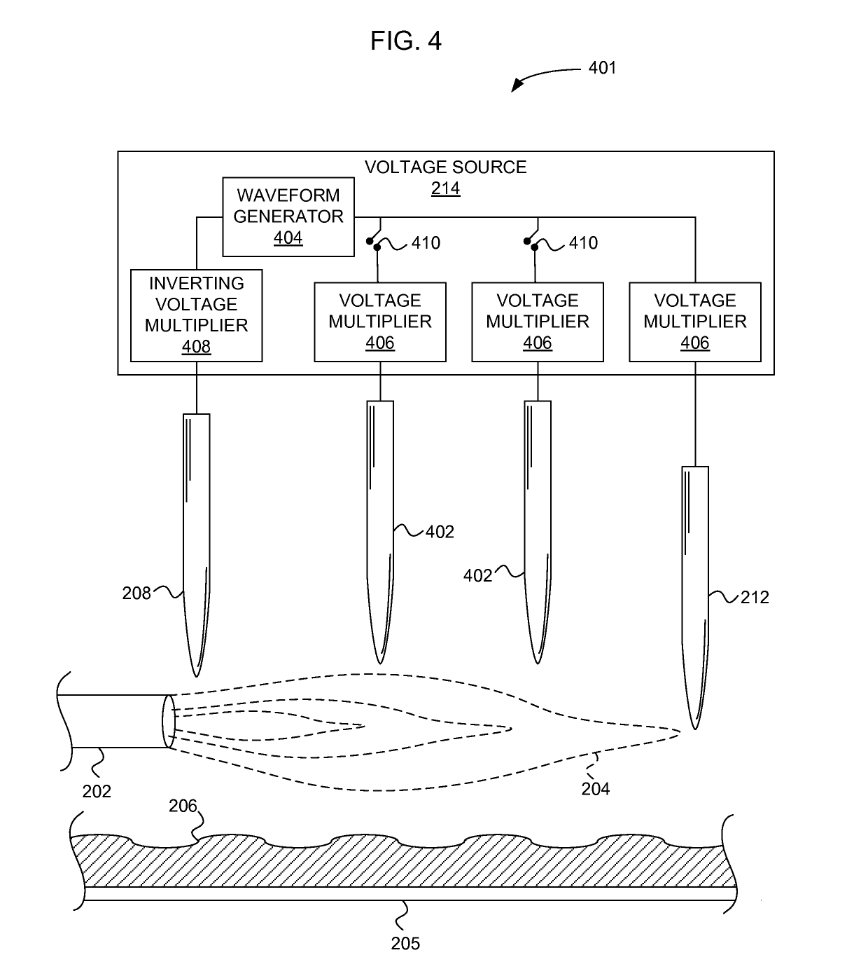

FIG. 4 is a diagram of a long flame process heater 401 incorporating one or more ladder electrodes 402 disposed at one or more location(s) intermediate to the charge electrode 208 and the field electrode 212, according to an embodiment. The ladder electrode(s) 402 may provide a structure for stretching flame 204, carrying a voltage or majority charge 210, to the field electrode 212 via a series of smaller steps. Ladder electrodes 402 may be configured to sequentially extend the length of the flame 204 to reach the field electrode 212. The voltage source 214 may include a waveform generator 404 configured to generate a waveform corresponding to voltages applied to the electrodes 208, 212, 402. The waveform generator 404 may be operatively coupled to one or more voltage multipliers 406 and an inverting voltage multiplier 408. One or more switches 410 may be provided to selectively couple voltage source 214 to the ladder electrodes 402. The inverting voltage multiplier 408 may be provided to keep the charge electrode 208 in voltage opposition to the instantaneous voltage of the field electrode 212 and ladder electrode(s) 402.

The switch(es) 410 may be configured to selectively couple the waveform generator 404 to one or more voltage multiplier(s) 406 associated with ladder electrodes 402, as depicted. Optionally, a single voltage multiplier 406 may be coupled to the waveform generator 404, and the switch(es) 410 may be configured to selectively couple the output from the single voltage multiplier 406 to the electrodes 402, 212. The depicted embodiment 401 may have an advantage of relatively low voltage switches, at the expense of more voltage multipliers 406. The alternative embodiment may operate with fewer voltage multipliers 406, but with the complication of high voltage switching. High voltage switching may be provided using reed switches, for example.

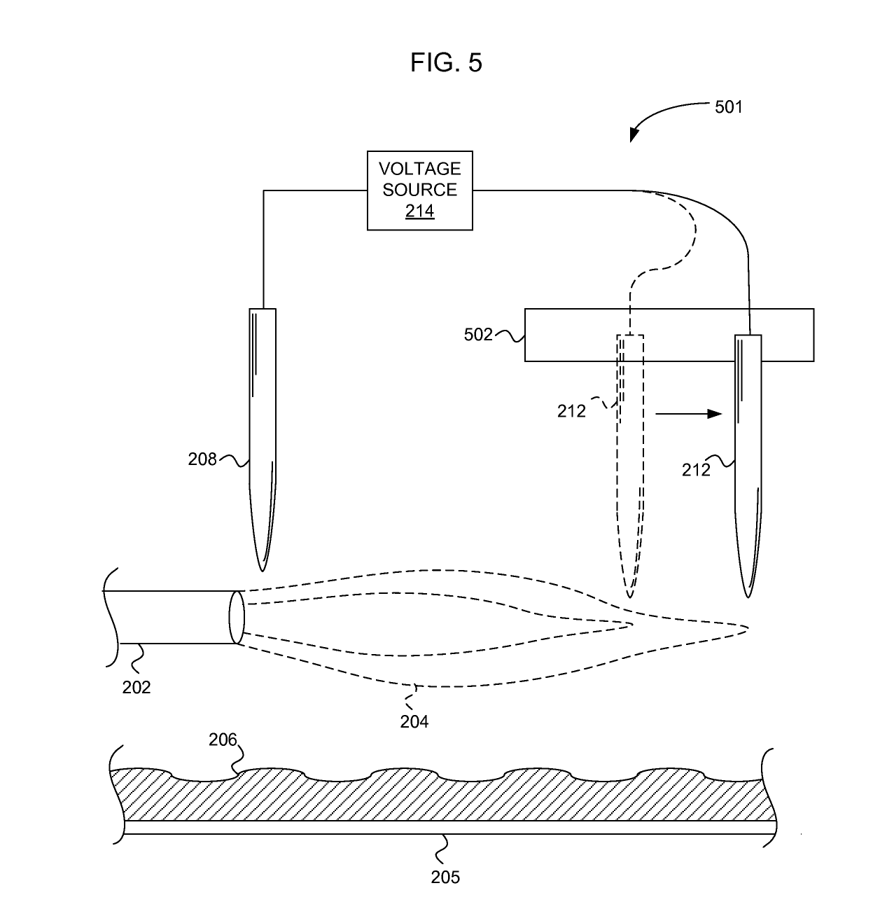

FIG. 5 is a block diagram of a long flame process heater 501 including a field electrode positioning mechanism 502, according to an embodiment. The field electrode positioning mechanism 502 may be configured to move the field electrode 212 from an intermediate position to a distal position to lengthen the flame 204.

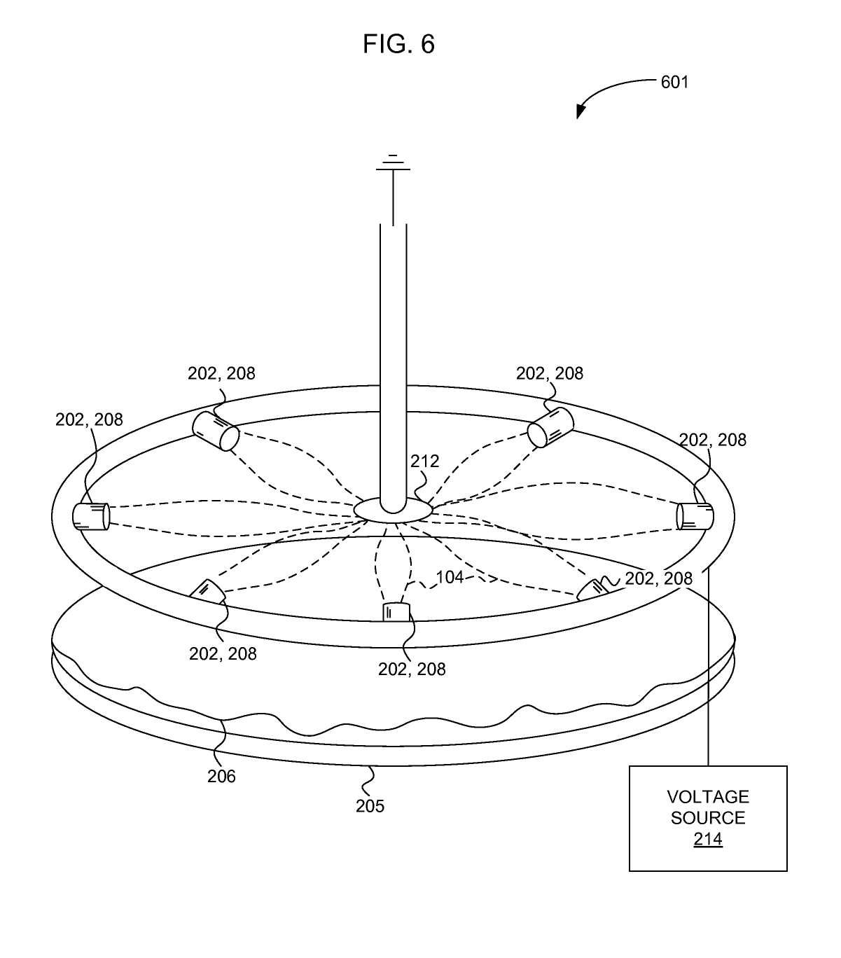

FIG. 6 is a diagram of a long flame process heater 601 with a plurality of charge electrodes 208 disposed around one or more centrally located field electrodes 212, according to an embodiment. The charge electrodes 208 may be coextensive with burners 202, may be arranged peripheral to a heating area corresponding to a process material 206, and may cooperate with one or more centrally located field electrodes 212. The locations of the charge electrodes 208 and the field electrodes 212 may be configured to cause an electric field strength to increase from moderate field strength proximate to the charge electrodes 208 to a higher field strength proximate to the one or more centrally located field electrodes 212. The embodiment 601, as shown, may provide a circular heating area. Alternative embodiments may include burners 202 and charge electrodes 208 distributed differently, and may provide heating areas of different geometry.

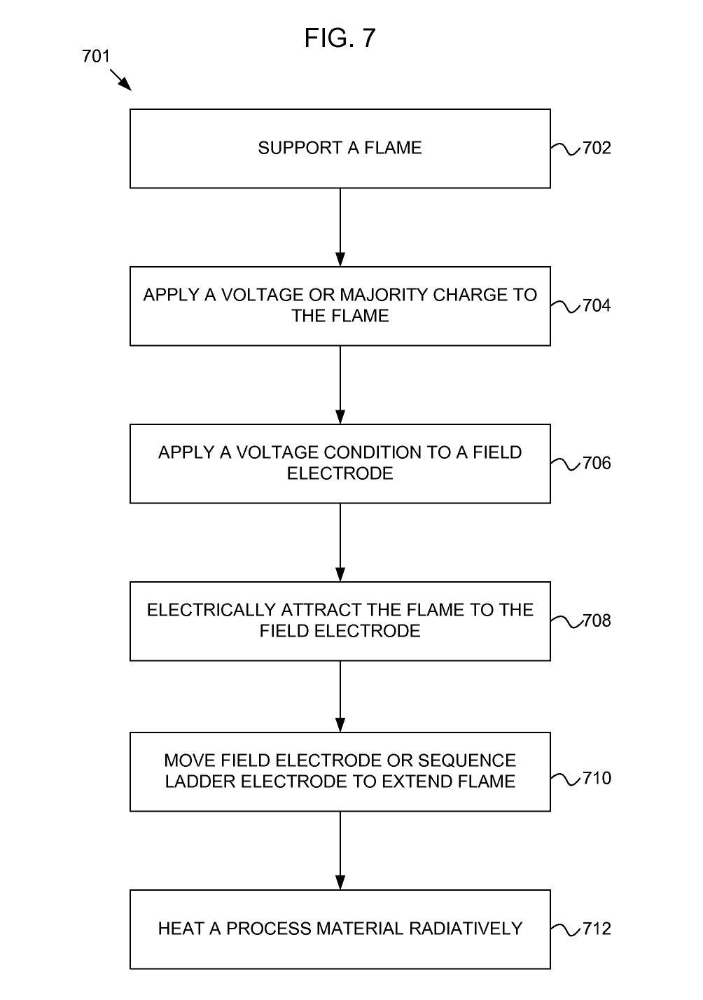

FIG. 7 is a flow chart showing a method 701 for radiantly heating a process material with a flame, according to an embodiment. Beginning with step 702, a flame may be supported proximate to a process material. For example, the axis of the flame may be parallel to the process material, such as by crossing an imaginary axis defined as generally normal to the surface of the process material. The flame may be caused to radiate electromagnetic energy in the infrared and visible light ranges responsive to the application of an electric field described below. The emitted light (especially the infrared light) may cause radiation heating of the process material. Radiation heating may be desirable for some processes.

Proceeding to step 704, the flame may be caused to carry a voltage or a majority charge. For example, a voltage source may apply a DC voltage to a charge electrode and/or constant-sign charges to the flame (as shown in FIG. 2, above). Alternatively, the voltage source may apply a time-varying voltage to the charge electrode and/or time-varying charge signs to the flame. The time-varying voltage may be a periodic voltage waveform having a frequency between 50 and 1500 Hz, for example. In some embodiments, the time-varying voltage may have a frequency between 200 and 800 Hz. A periodic voltage waveform applied to charge electrode may have a voltage between 1 kV and 100 kV, for example. The periodic voltage waveform may have a shape including a sinusoidal wave, a square wave, a sawtooth wave, a triangular wave, a truncated triangular wave, a logarithmic wave, an exponential wave, or an arbitrary wave shape including combinations of the above.

The method 701 may include step 706, wherein a voltage condition is applied to a field electrode. The voltage condition may be selected to attract the voltage or majority charge carried by the flame, and thereby attracts the flame itself toward the field electrode. Applying the voltage condition to the field electrode may include applying a voltage having a sign opposite to the voltage or majority charge carried by the flame. Alternatively, applying the voltage condition to the field electrode can include holding the field electrode at or near voltage ground. Alternatively or additionally, applying the voltage condition to the field electrode may include allowing the field electrode to electrically float. If, in step 704 the flame is caused to carry a voltage or majority charge having a sign that varies in time, then allowing the field electrode to electrically float may cause the field electrode to take on a voltage that follows the voltage or majority charge carried by the flame. A time-varying electrical potential may thus be created between the flame and the field electrode.

In experiments, it was found that the attraction of the flame to a conductive surface such as the field electrode varies with the magnitude and polarity of the voltage applied to the flame. In the case of alternating voltages of relatively low magnitude, the flame was particularly attracted to the conductive surface during the positive half-cycles of applied voltage, with less attraction observed during the negative half-cycles. Increasing the magnitude of the applied voltage created a larger concentration of charged particles in the flame and resulted in the flame being more equally attracted to the conductive surface on both positive and negative half-cycles of the applied alternating voltage.

Considering again step 706, applying a voltage condition to the field electrode may include placing the field electrode in continuity with a ground potential.

Proceeding to step 708 the voltage or majority charge carried by the flame may be attracted toward the field electrode. The attraction of the voltage or majority charge may, in turn, stretch the flame toward the field electrode. Stretching the flame toward the field electrode may extend the flame across a process material. Extending the flame toward the field electrode may result in a longer flame than can be reliably created without the electric field. The longer flame may result in more repeatable or more consistent radiant heating of the process material than can be reliably achieved without attracting the voltage or majority charge toward the field electrode.

Experiments were aimed at increasing the distance that a flame could be extended by applying a voltage to the flame, since it is difficult to attract a flame to a conductive surface located a long distance from the flame. Large voltages placed on the flame could cause such attraction to occur at moderate distances. Therefore, it is useful to have a start-up or fault recovery approach that can lengthen a flame to a desired extension to the field electrode.

Optionally, the method 701 may include step 710. In step 710, the flame may be extended toward a distal location. In a first approach, a sequence of ladder electrodes may be energized to extend the flame. Causing the sequence of ladder electrodes to extend the flame may include providing one or more ladder electrodes located at one or more intermediate locations between a burner supporting the flame and the field electrode, coupling at least one ladder electrode to the voltage condition selected to attract the flame, and uncoupling less distal ladder electrode(s). This can cause the flame to be sequentially attracted to more distal ladder electrode(s) or the field electrode as the flame is transferred from electrode to electrode.

Alternatively, step 710 may include moving the field electrode to extend the flame. Beginning with the field electrode in a proximate location to the flame, the voltage condition may be applied to the field electrode in step 706 attracting the flame to the field electrode in step 708. The field electrode may then be moved to a more distal location in step 710 to extend the flame.

Proceeding to step 712, the process material may be heated via radiation heat transfer from the extended flame. Heating the process material via radiation heat transfer from the extended flame may include, for example, producing a calcined material, drying a material, heat treating a material, cooking a food, browning a food, baking a food, or searing a food.

One example of the use of a long flame process heater to heat a process material is a kiln, which may include an electrode or electrode array supported relative to the process material. A voltage controller may be operatively coupled to the electrode or electrode array. The voltage controller may be configured to drive the electrode or electrode array to one or more of a sequence of electric field states to extend a combustion reaction across the process material, the combustion reaction being configured to form a radiation heat source for the process material.

A method for using a long flame process heater for making a product may include the steps of heating a process material by radiation from a flame, and controlling the flame shape to expose the process material to radiation heating by applying one or more of a sequence of electric fields to the flame.

A system for making a high-consistency calcined material using a long flame process heater may include a rotating or stationary process vessel configured to receive a continuous stream of a raw material; a burner configured to support a flame, the flame being disposed to selectively heat the raw material, an intermediate product reacted from the raw material, and a calcined material made from the intermediate product (collectively, process material) and to provide substantially all the calcining energy received by the process material; and an electric field application system configured to control a spatial distribution of a radiant energy source comprising the flame by controlling one or more electric fields impressed upon the flame and a region near the flame. The spatial distribution of the radiant energy source may correspond substantially to radiation heating received by the process material. The electric field application system may comprise one or more antennas configured to apply the one or more electric fields operatively coupled to the flame; and one or more voltage sources operatively coupled to the one or more antennas, the voltage sources being configured to cause the one or more antennas to establish, maintain, or vary the flame shape.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A long flame process heater, comprising:
a burner configured to support a flame along an axis substantially parallel to a process material;
a charge electrode configured to impart a first polarity voltage or majority charge to the flame; and
a field electrode disposed distal to the burner and configured to electrically attract the first polarity voltage or majority charge with a second voltage different from the first voltage and to thereby cause the flame to extend toward the field electrode.

2. The long flame process heater of claim 1, wherein the second electrode is configured to carry a voltage having a second polarity opposite to the first polarity.

3. The long flame process heater of claim 1, wherein the second electrode is configured for electrical continuity with a voltage ground.

4. The long flame process heater of claim 1, further comprising:
a process material support mechanism or conveyor configured to support or convey the process material while it is exposed to radiation heat transfer from the flame.

5. The long flame process heater of claim 4, wherein the process material support mechanism includes a rack configured to support a batch of process material.

6. The long flame process heater of claim 4, wherein the conveyor includes a rotating kiln shell.

7. The long flame process heater of claim 1, wherein the charge electrode and the field electrode are configured to cooperate to draw the flame to a stable length longer than a stable length achievable without the cooperation of the charge electrode and the field electrode.

8. The long flame process heater of claim 1, wherein the charge electrode and the field electrode are configured to cooperate to draw the flame to a stable length having at least one of less flicker or less length variation than a stable length achievable without the cooperation of the charge electrode and the field electrode.

9. The long flame process heater of claim 1, further comprising:
a plurality of ladder electrodes disposed at locations intermediate to the charge electrode and the field electrode and configured to sequentially extend the length of the flame to reach the field electrode.

10. The long flame process heater of claim 9, wherein the ladder electrodes are configured to sequentially extend the length of the flame to reach the field electrode.

11. The long flame process heater of claim 1, further comprising:
a field electrode positioning mechanism configured to move the field electrode from an intermediate position to a distal position to lengthen the flame.

12. The long flame process heater of claim 11, wherein the field electrode positioning mechanism is configured to move the field electrode from an intermediate position to a distal position to lengthen the flame.

13. The long flame process heater of claim 1, further comprising:
a voltage source operatively coupled to at least the charge electrode.

14. The long flame process heater of claim 13, wherein the voltage source is also operatively coupled to at least the field electrode.

15. The long flame process heater of claim 13, wherein the voltage source is configured to apply a DC voltage or constant sign charges to the charge electrode.

16. The long flame process heater of claim 13, wherein the voltage source is configured to apply a time-varying voltage or time-varying charge signs to the charge electrode.

17. The long flame process heater of claim 16, wherein the voltage source is configured to apply a periodic voltage waveform to the charge electrode, the periodic voltage waveform having a frequency between 50 and 1500 Hz.

18. The long flame process heater of claim 17, wherein the frequency of the periodic waveform is between 200 and 800 Hz.

19. The long flame process heater of claim 16, wherein the voltage source is configured to apply a periodic voltage waveform having a voltage between 1 kV and 80 kV to the charge electrode.

20. The long flame process heater of claim 16, wherein the voltage source is configured to apply a sinusoidal, square wave, sawtooth wave, triangular wave, truncated triangular wave, logarithmic, or exponential voltage waveform to the charge electrode.

21. The long flame process heater of claim 1, further comprising:
a sensing circuit configured to sense current flow between the charge electrode and the field electrode.

22. The long flame process heater of claim 21, further comprising:
one or more of voltage control logic, waveform duty cycle logic, waveform shape logic, or waveform frequency logic operatively coupled to the sensing circuit and configured to control one or more of voltage, waveform duty cycle, waveform shape, or waveform frequency responsive to the sensed current flow.

23. The long flame process heater of claim 21, wherein the charge electrode includes a plurality of charge electrodes arranged peripherally to a heating area;
wherein the field electrode includes one or more centrally located field electrodes; and
wherein the locations of the charge electrodes and the one or more centrally located field electrodes are configured to cause an electric field strength to increase from the field strength proximate to the charge electrodes to the field strength proximate to the one or more centrally located field electrodes.

24. A method for radiantly heating a process material with a flame, comprising:
supporting a flame along an axis parallel and proximate to a process material;
causing the flame to carry a voltage or a majority charge; and
attracting the voltage or majority charge carried by the flame, toward a field electrode to extend the flame across the process material.

25. The method of claim 24, further comprising:
applying a voltage condition to the field electrode selected to attract the voltage or majority charge carried by the flame.

26. The method of claim 25, wherein applying a voltage condition to the field electrode includes applying a voltage opposite in sign to the voltage or majority charge carried by the flame.

27. The method of claim 25, wherein applying a voltage condition to the field electrode includes allowing the field electrode to electrically float;
wherein causing the flame to carry a voltage or a majority charge includes causing the flame to carry a voltage or majority charge having a sign that varies in time; and
wherein allowing the field electrode to electrically float causes the field electrode to take on a voltage that follows the voltage or majority charge carried by the flame such that a time-varying electrical potential is created between the flame and the field electrode.

28. The method of claim 25, wherein applying a voltage condition to the field electrode includes placing the field electrode in continuity with a ground potential.

29. The method of claim 24, wherein attracting the voltage or majority charge carried by the flame toward a field electrode to extend the flame across the process material results in a longer flame than is reliably created without attracting the voltage or majority charge carried by the flame toward the field electrode.

30. The method of claim 24, wherein attracting the voltage or majority charge carried by the flame toward a field electrode to extend the flame across the process material results in more repeatable or more consistent radiant heating of the process material than is reliably achieved without attracting the voltage or majority charge carried by the flame toward the field electrode.

31. The method of claim 24, further comprising:
causing a sequence of ladder electrodes to extend the flame.

32. The method of claim 31, wherein causing a sequence of ladder electrodes to extend the flame further comprises:
providing one or more ladder electrodes located at one or more intermediate locations between a burner supporting the flame and the field electrode;
coupling at least one ladder electrode to the voltage condition selected to attract the flame; and
uncoupling less distal ones of the at least one ladder electrode to cause the flame to be attracted to a more distal ladder electrode or to the field electrode.

33. The method of claim 24, further comprising:
moving the field electrode parallel to the axis to extend the flame.

34. The method of claim 24, further comprising:
heating the process material via radiation heat transfer from the extended flame.

35. The method of claim 34, wherein heating the process material via radiation heat transfer from the extended flame includes producing a calcined material, drying a material, heat treating a material, cooking a food, browning a food, baking a food, or searing a food.

36. A kiln configured to heat a process material, comprising:
an electrode or electrode array supported relative to the process material;
a voltage controller operatively coupled to the electrode or electrode array;
wherein the voltage controller is configured to drive the electrode or electrode array to one or more of a sequence of electric field states to extend a combustion reaction across the process material, the combustion reaction being configured to comprise a radiation heat source for the process material.

37. A method for making a product by a process, comprising:
heating a process material by radiation from a flame; and
controlling the flame shape to expose the process material to radiation heating by applying one or more of a sequence of electric field states to the flame.

38. A system for making a high consistency calcined material, comprising:
a rotating or stationary process vessel configured to receive a continuous stream of a raw material;
a burner configured to support a flame, the flame being disposed to selectively heat the raw material, an intermediate product reacted from the raw material, and a calcined material made from the intermediate product (collectively, process material) and to provide substantially all the calcining energy received by the process material; and
an electric field application system configured to control a spatial distribution of a radiant energy source comprising the flame by controlling one or more electric fields impressed upon the flame and a region near the flame.

39. The system for making a high consistency calcined material of claim 38, wherein the spatial distribution of the radiant energy source corresponds substantially to radiation heating received by the process material.

40. The system for making a high consistency calcined material of claim 38, wherein the electric field application system further comprises:
one or more antennas configured to apply the one or more electric fields operatively coupled to the flame; and
one or more voltage sources operatively coupled to the one or more antennas, the voltage sources being configured to cause the one or more antennas to establish, maintain, or vary the flame shape.
